(19) United States
(12) Patent Application Publication
(10) Pub. No.: US 2026/0072404 A1
(43) Pub. Date: Mar. 12, 2026

(54) METHOD FOR MANUFACTURING A DIAL

(71) Applicant: The Swatch Group Research and Development Ltd, Marin (CH)

(72) Inventors: Marek DOVCIK, Mougins (FR); Nicolas François, Neuchâtel (CH); Sophie Napoli, Neuchâtel (CH)

(73) Assignee: The Swatch Group Research and Development Ltd, Marin (CH)

(21) Appl. No.: 19/282,024

(22) Filed: Jul. 28, 2025

(30) Foreign Application Priority Data
Sep. 9, 2024 (EP) 24199214.8

(51) Int. Cl. G04B 19/12

(52) U.S. Cl. CPC G04B 19/12

(57) ABSTRACT

The invention relates to a method for manufacturing a dial comprising the following steps: forming a first part of the dial from a first resin filled with reflective particles, the first part forming a bed; casting at least one second resin into the bed to form the second part of the dial and obtain a dial; thoroughly or selectively polishing the dial to locally reveal the first resin comprising the reflective particles.

### CROSS REFERENCE TO RELATED APPLICATION

This application claims priority to European Patent Application No. 24199214.8 filed September 09, 2024, the entire contents of which are incorporated herein by reference.

### TECHNICAL FIELD OF THE INVENTION

The invention relates to the field of horology. More specifically, it relates to a method for manufacturing a dial that looks like a precious stone.

In this text, the term “precious stone” refers interchangeably to precious and semi-precious stones.

### Technological background

Composites made from precious stones are commonly used in fields such as horology and jewellery. The desired properties may vary, but they are generally aesthetic and mechanical, yet relatively expensive.

Therefore, for economic reasons, horology components that imitate the appearance of precious stones have been developed using polymer materials.

However, manufacturing such decorative elements always requires the use of synthetically-produced stones, which inevitably entails high manufacturing costs.

There is therefore a need for a decorative element that is inexpensive to manufacture while preserving the appearance of precious stones, namely their brilliance or sparkle, thus imparting a luxurious appearance to the decorated object.

### SUMMARY OF THE INVENTION

To this end, the present invention relates to a method for manufacturing a dial comprising the following steps:

forming a first part of the dial from a first resin filled with reflective particles, the first part forming a bed;

casting at least one second resin into the bed to form the second part of the dial and obtain a dial;

thoroughly or selectively polishing the dial to locally reveal the first resin comprising the reflective particles.

According to other advantageous variants of the invention:

the first resin is a thermoplastic resin, an epoxy resin, or a polyurethane resin, and the second resin is an epoxy resin or a polyurethane resin;

the reflective particles are chosen among phosphorescent, fluorescent, metallic, precious, semi-precious particles or a combination of these particles;

the second resin comprises at least one additive chosen among colourants, pigments, UV blockers or a combination of these additives;

several resins are cast into the bed of the first part of the dial;

the second resin is cast into the bed of the first part of the dial so as to partially fill the bed;

the filler of reflective particles integrated into the first resin is comprised between 0.001% and 5%;

the filler of reflective particles integrated into the first resin is comprised between 0.02% and 1%;

the bed comprises decorative elements formed in positive relief;

the decorative elements are indexes, appliques, logos or geometric forms.

The present invention also relates to a dial produced by a method as described above.

### BRIEF DESCRIPTION OF THE FIGURES

Other features and advantages of the invention will become apparent from the following detailed description, given by way of non-limiting example, with reference to the attached drawings in which:

FIG. 1 shows a step in the production of a dial according to the present invention;

FIG. 2 shows the dial obtained after the step in FIG. 1 has been performed;

FIG. 3 shows a dial according to a first embodiment of the method according to the present invention;

FIG. 4 shows a dial according to a second embodiment of the method according to the present invention;

FIG. 5 shows a dial according to a third embodiment of the method according to the present invention.

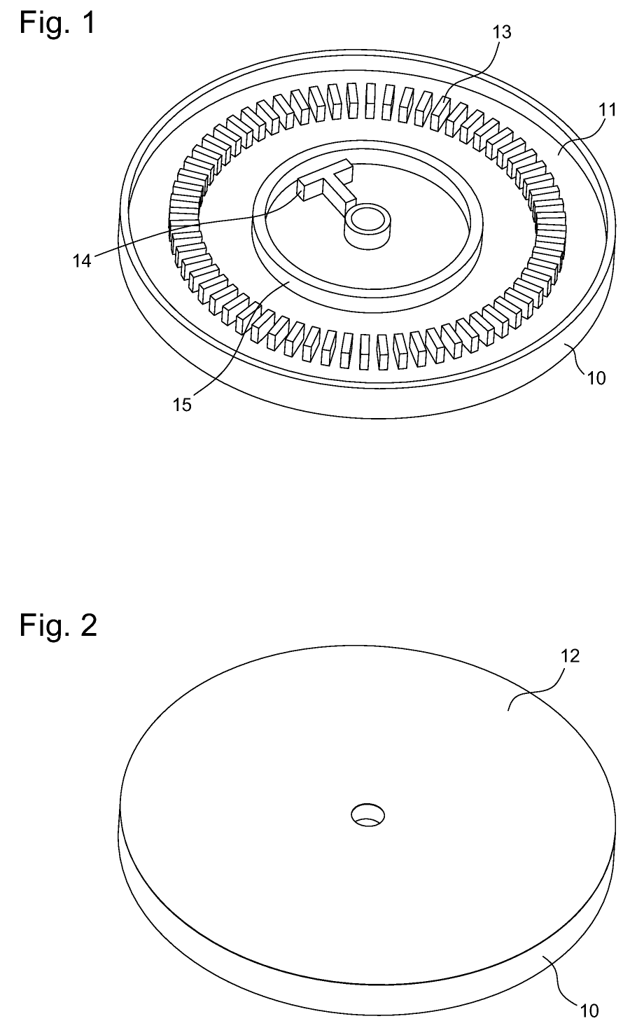

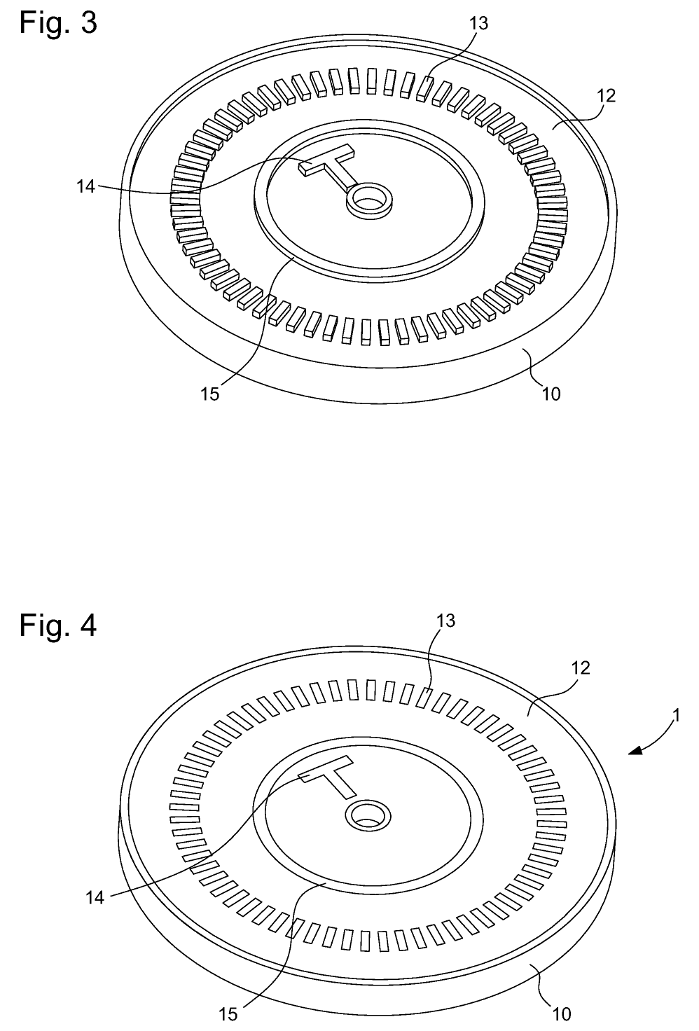

### DETAILED DESCRIPTION OF THE INVENTION

The invention relates to a method for manufacturing a dial 1 comprising the following steps:

forming a first part 10 of the dial from a first resin filled with reflective particles, the first part forming a bed 11;

casting at least one second resin into the bed 11 to form a second part 12 of the dial and obtain a dial 1;

thoroughly or selectively polishing the dial 1 to locally reveal the first resin comprising the reflective particles.

The first resin is chosen among thermoplastic resins, epoxy resins or polyurethane resins, and the second resin is chosen among epoxy or polyurethane resins. In general, these resins harden by polymerisation of monomers and/or of pre-polymers and/or by cross-linking. After hardening in the presence of a hardener, it adds hardness properties to the composite material. The resins are also colourless after hardening. In other words, they do not change the colour or the appearance of the particles present in the resin after hardening.

If no hardener is present, the composite resin is a paste with a more or less liquid consistency.

The resin or the thermoplastic polymer is chosen so as to have an optical transmission coefficient of more than 80% so that the visual appearance of the dial tends to resemble as closely as possible that of a precious stone.

The reflective particles added to the first resin help to increase the refractive index of the dial and increase its reflection so that its appearance is similar to that of a precious stone. The reflective particles account for between 0.001% and 5% by weight of the first filled resin, and preferably between 0.02% and 1%.

The particles can have any type of geometric form, for example spherical, parallelepipedal, cylindrical or oval, and have a size comprised between 1 µm and 100 µm.

The particles can be chosen among phosphorescent, fluorescent, metallic, precious, semi-precious particles or a combination of these particles.

The particles can have any type of geometric form, for example spherical, parallelepipedal, cylindrical or oval.

The particles can be chosen among phosphorescent, fluorescent, metallic, precious, semi-precious particles, mother-of-pearl particles or a combination of these particles.

According to one embodiment of the invention, the second resin comprises at least one additive chosen among colourants, pigments, UV blockers or a combination of these additives.

The first part of the dial can be produced by moulding, injection moulding, additive manufacturing or by machining a thermoplastic or thermosetting pallet stone.

As can be seen in the figures, the bed 11 of the first part 10 of the dial comprises decorative elements 13, 14, 15 formed in positive relief; these decorative elements 13, 14, 15 can be indexes, appliques, logos or geometric shapes.

These decorative elements are brought out when the dial is polished or can be directly apparent if a second transparent resin is cast into the bed 11.

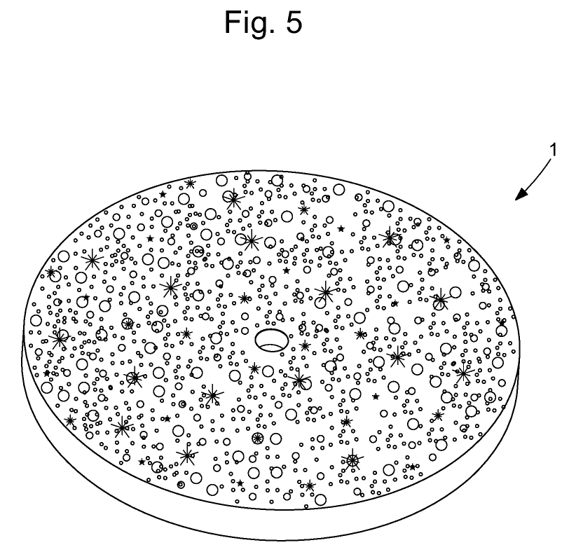

According to another embodiment illustrated in FIG. 5, the dial can comprise no decorative elements and only have a surface with the appearance of a precious stone, that is, a brilliant and/or sparkling appearance.

Thus, the invention also relates to a method for manufacturing a composite material comprising the following steps:

forming a first part 10 of the dial 1 from a first resin filled with reflective particles, the first part forming a bed 11;

casting at least one second resin into the bed 11 to form a second part 12 of the dial and obtain a dial 1;

thoroughly or selectively polishing the dial 1 to reveal the first resin comprising the reflective particles.

The first resin and the reflective particles are generally in the form of a paste; this mixture can be homogenised by being passed through a grinder. The grinding step not only homogenises the mixture of but also breaks up any aggregates formed by the particles in the resin.

The formation of the resin, with or without hardener, generally leads to the incorporation of air bubbles in the paste.

Therefore, in order to remove these air bubbles, the method can comprise a gas removal step. This step can advantageously be carried out using a centrifuge or a centrifuge/planetary mixer with a partial vacuum.

As required, at least one hardener can be added to the resin. As already indicated, this hardener enables the resin to be polymerised and/or cross-linked.

After adding the hardener, the mixture can be homogenised using a helix blender, for example.

Once mixed, the resin can be cast or injected to form the first part of the dial.

According to a particular embodiment, the first part of the dial is placed in a vacuum chamber, thereby simultaneously removing air and forming the resin.

The mould can optionally be heated, as increasing the temperature liquefies the resin and accelerates its hardening.

Then, a second resin comprising one or more additives such as colourants, pigments and UV blockers is prepared similarly to the first resin.

This second resin is cast into the bed of the first part of the dial, so as to fill the bed completely or partially and form a dial.

According to one particular embodiment, several resins with different compositions can be cast into the bed. The resins can be cast on top of each other or locally cast in compartments of the bed.

The second resin or one of the supplementary resins can be transparent to add a three-dimensional effect to the dial.

Lastly, the dial is completely or selectively polished to reveal the first resin comprising the reflective particles on the visible/observable face of the dial.

The present invention also relates to a dial formed using the method according to the invention.

1. A method for manufacturing a dial, comprising the following steps:
- forming a first part of the dial from a first resin filled with reflective particles, the first part forming a bed;
- casting at least one second resin into the bed to form a second part of the dial and obtain the dial;
- thoroughly or selectively polishing the dial to locally reveal the first resin comprising the reflective particles.

2. The method according to claim 1, wherein the first resin is a thermoplastic resin, an epoxy resin, or a polyurethane resin, and the second resin is an epoxy resin or a polyurethane resin.

3. The method according to claim 1, wherein the reflective particles are chosen among phosphorescent, fluorescent, metallic, precious, semi-precious particles or a combination of these particles.

4. The method according to claim 1, wherein the second resin comprises at least one additive chosen among colourants, pigments, UV blockers or a combination of these additives.

5. The method according to claim 1, wherein a plurality of resins are cast into the bed of the first part of the dial.

6. The method according to claim 1, wherein the second resin is cast into the bed of the first part of the dial so as to partially fill the bed.

7. The method according to claim 1, wherein the filler of reflective particles integrated into the first resin is comprised between 0.001% and 5%.

8. The method according to claim 1, wherein the filler of reflective particles integrated into the first resin is comprised between 0.02% and 1%.

9. The method according to claim 1, wherein the bed comprises decorative elements formed in positive relief.

10. The method according to claim 9, wherein decorative elements are indexes, appliques, logos or geometric forms.

11. A dial made by the method according to claim 1.
